(19) United States
(12) Patent Application Publication
(10) Pub. No.: US 2019/0099845 A1
(43) Pub. Date: Apr. 4, 2019

(54) LOW MELTING POINT POTASSIUM ALUMINUM FLUORIDE FLUX AGENT

(71) Applicant: Honeywell International Inc., Morris Plains, NJ (US)

(72) Inventors: Elisabeth Memmel, Seelze (DE); Jessica Maurer, Wunstorf (DE); Christian N. Werner, Hannover (DE); Anja Nieland, Seelze (DE)

(21) Appl. No.: 16/000,176

(22) Filed: Jun. 5, 2018

Related U.S. Application Data
(60) Provisional application No. 62/567,985, filed on Oct. 4, 2017.

(51) Int. Cl. B23K 35/362; C04B 35/553; C04B 35/626

(52) U.S. Cl. CPC B23K 35/362; C04B 35/553; C04B 2235/606; C04B 2235/445; C04B 35/62655

(57) ABSTRACT

The present disclosure provides a potassium aluminum fluoride (KAlF₄) flux agent having improved properties such as a lower melting point which allows for the use of solders and alloys with lower melting points. The potassium aluminum fluoride (KAlF₄) flux agent may also allow for faster brazing of standard alloys.

### CROSS REFERENCE TO RELATED APPLICATIONS

This application claims the benefit under Title 35, U.S.C. § 119(e) of U.S. Provisional Patent Application Ser. No. 62/567,985, entitled LOW MELTING POINT POTASSIUM ALUMINUM FLUORIDE FLUX AGENT, filed on Oct. 4, 2017, the entire disclosure of which is expressly incorporated by reference herein.

### FIELD OF THE INVENTION

The present disclosure relates generally to a potassium aluminum fluoride flux agent with a low melting point.

### BACKGROUND

Brazing operations, which are used in certain manufacturing operations, such as in heat exchanger manufacturing, have traditionally occurred in vacuum furnaces. More recently, a brazing technique known as “controlled atmosphere brazing (CAB)” has become accepted by the automotive industry for making brazed aluminum heat exchangers. Illustrative end uses of CAB brazed aluminum heat exchangers include radiators, condensers, evaporators, heater cores, air charged coolers and inter-coolers.

CAB brazing is preferred over vacuum furnace brazing due to improved production yields, lower furnace maintenance requirements, greater braze process robustness and lower capital cost of the equipment employed.

In a CAB process, a fluxing or flux agent is applied to the pre-assembled component surfaces to be jointed. The flux agent is used to dissociate or dissolve and displace the aluminum oxide layer that naturally forms on aluminum alloy surfaces. The flux agent is also used to prevent reformation of the aluminum oxide layer during brazing and to enhance the flow of the brazing alloy. Illustrative flux agents include alkaline metal or alkaline earth metal fluorides or chlorides.

Fluoride-based fluxes are generally preferred for brazing aluminum or aluminum alloys because they are inert or non-corrosive, as are aluminum and its alloys, yet are substantially water insoluble after brazing, and are commonly used by the automotive industry in the manufacture of aluminum and aluminum alloy heat exchangers.

In general, the melting point of the flux agents may need to be adjusted depending on the alloy used and the solder. Current flux agents, including existing potassium aluminum fluoride flux agents, have a relatively narrow range of melting points which may render the flux agents unsuitable for certain applications, e.g., brazing of low melting aluminum alloys. What is needed is a fluoride-based flux agent which extends the lower end of the melt range and is an improvement over the foregoing.

### SUMMARY

The present disclosure provides a potassium aluminum fluoride (KAlF₄) flux agent, having improved properties such as a lower melting point which allows for the use of solders and alloys with lower melting points. The potassium aluminum fluoride (KAlF₄) flux agent also allows for faster brazing of standard alloys.

According to an embodiment of the present disclosure, a KAlF₄ flux agent is provided. The KAlF₄ flux agent comprises a K:Al ratio between 1.3:1 and 1.5:1; a K:F ratio between 1.3:4 and 1.5:4; and a melting point between 530° C. and about 550° C. In one more particular embodiment of any of the above embodiments, the flux agent has a phase composition of KAlF₄ between about 5 wt. % and about 60 wt. % and of K₂AlF₅(H₂O) between 40 wt. % and 95 wt. %, based on the total composition of the KAlF₄ and K₂AlF₅(H₂O) phases in the flux agent. In one more particular embodiment of any of the above embodiments, the flux agent has a phase composition of KAlF₄ between about 15 wt. % and about 50 wt. % and of K₂AlF₅(H₂O) between 50 wt. % and 85 wt. %, based on the total composition of the KAlF₄ and K₂AlF₅(H₂O) phases in the flux agent. In one more particular embodiment of any of the above embodiments, the flux agent has a melting point between 535° C. and 545° C. In one more particular embodiment of any of the above embodiments, the melting point is about 540° C. In one more particular embodiment of any of the above embodiments, the Al:F ratio is 1:4.

According to an embodiment of the present disclosure, a KAlF₄ flux agent is provided. The KAlF₄ flux agent comprises a K:Al ratio between 1.3:1 and 1.5:1; a K:F ratio between 1.3:4 and 1.5:4; a Al:F ratio of 1:4; and a phase composition of KAlF4 between about 5 wt. % and about 60 wt. % and of K₂AlF₅(H₂O) between 40 wt. % and 95 wt. %, based on the total composition of the KAlF₄ and K₂AlF₅(H₂O) phases in the flux agent. In one more particular embodiment of any of the above embodiments, the flux agent has a phase composition of KAlF₄ between about 15 wt. % and about 50 wt. % and of K₂AlF₅(H₂O) between 50 wt. % and 85; wt. %, based on the total composition of the KAlF₄ and K₂AlF₅(H₂O) phases in the flux agent. In one more particular embodiment of any of the above embodiments, the flux agent has a melting point between 535° C. and 545° C. In one more particular embodiment of any of the above embodiments, the melting point is about 540° C.

According to an embodiment of the present disclosure, a method of producing a flux agent is provided. The method comprises providing a reaction vessel containing water; adding aluminum oxide to the reaction vessel under agitation; adding an aqueous hydrofluoric acid to form a reaction mixture, the aqueous hydrofluoric acid having a concentration between 50 wt. % and 75 wt. %; adding an aqueous potassium hydroxide to the reaction mixture, wherein the aqueous potassium hydroxide has a concentration between 45 wt. % and 55 wt. %; and cooling the reaction mixture to between 35° C. and 45° C.; and spray drying the reaction mixture to produce the flux agent, wherein the flux agent has a K:Al ratio between 1.3:1 and 1.5:1. In one more particular embodiment of any of the above embodiments, the flux agent has a melting point between 530° C. and 550° C. In one more particular embodiment of any of the above embodiments, the melting point is between 535° C. and 545° C. In one more particular embodiment of any of the above embodiments, the melting point is 540° C. In one more particular embodiment of any of the above embodiments, the K:F ratio is between 1.3:4 and 1.5:4. In one more particular embodiment of any of the above embodiments, the flux agent has a phase composition of KAlF₄ between about 5 wt. % and about 60 wt. % and of K₂AlF₅(H₂O) between 40 wt. % and 95 wt. %, based on the total composition of the KAlF₄ and K₂AlF₅(H₂O) phases in the flux agent. In one more particular embodiment of any of the above embodiments, the flux agent has a phase composition of KAlF₄ between about 15 wt. % and about 50 wt. % and of K₂AlF₅(H₂O) between 50 wt. % and 85 wt. %, based on the total composition of the KAlF₄ and K₂AlF₅(H₂O) phases in the flux agent.

### BRIEF DESCRIPTION OF THE DRAWINGS

FIG. 1 is a flowchart illustrating a method of preparing a flux agent.

Corresponding reference characters indicate corresponding parts throughout the several views. The exemplifications set out herein are provided to illustrate certain exemplary embodiments and such exemplifications are not to be construed as limiting the scope in any manner.

### DETAILED DESCRIPTION

### I. General Description

The present disclosure provides a flux agent with a lower melting point. The flux agent is formed by mixing and reacting raw materials including aluminum oxide (Al₂O₃), aqueous hydrofluoric acid (HF), and aqueous potassium hydroxide (KOH) as discussed below. The flux agent has a reduced melting point as compared to existing potassium aluminum fluoride flux agents, which facilitates the use of solders and alloys with lower melting points. The lower melting point may also allow for faster brazing of standard alloys. Moreover, due to earlier starting of the brazing process, cycle times may be reduced, and the output range of brazed parts may be increased.

As shown below, a flux agent of the present disclosure includes potassium aluminum fluoride (hereinafter KAlF₄) and is produced by the series of reactions shown below.

Al₂O₃+8HF→2HAlF₄+3H₂O (I)

HAlF₄+KOH→KAlF₄+H₂O (II)

As shown above, reaction I includes reacting aluminum oxide with aqueous hydrofluoric acid to create the reaction intermediate of HAlF₄. The reaction intermediate HAlF₄ is then neutralized with aqueous potassium hydroxide resulting in a potassium aluminum fluoride (KAlF₄) precursor and water as shown in reaction II. The KAlF₄ precursor is then isolated by spray drying the reaction mixture resulting in a low melting KAlF₄ as discussed further herein.

The flux agents disclosed herein include higher potassium content than existing KAlF₄ flux agents. In particular, the present KAlF₄ flux agents have a potassium to aluminum to fluorine molar ratio that may be as little as 1.3:1.0:4.0, 1.35:1.0:4.0, or 1.4:1.0:4.0, or as great as 1.45:1.0:4.0, 1.475:1.0:4.0, or 1.5:1.0:4.0, or within any range defined between any two of the foregoing values such as between 1.3:1.0:4.0 to 1.5:1.0:4.0; 1.35:1.0:4.0 to 1.475:1.0:4.0, or 1.4:1.0:4.0 to 1.45:1.0:4.0, for example. The ratio varies based on the relative amounts of the raw materials (aluminum oxide, hydrofluoric acid, and potassium hydroxide) used in the method described below for forming the KAlF₄ flux agent.

Additionally, the present KAlF₄ flux agents have a potassium to aluminum molar ratio that may be as little as 1.3:1.0, 1.35:1.0, or 1.4:1.0, or as great as 1.45:1.0, 1.475:1.0, or 1.5:1.0, or within any range defined between any two of the foregoing values such as 1.3:1.0 to 1.5:1.0, 1.35:1.0 to 1.475:1.0, or 1.4:1.0 to 1.45:1.0, for example.

Similarly, the present KAlF₄ flux agents have a potassium to fluorine molar ratio that may be as little as 1.3:4.0, 1.35:4.0, or 1.4:4.0, or as great as 1.45:4.0 1.475:4.0, or 1.5:4.0, or within any range defined between any two of the foregoing values such as 1.3:4.0 to 1.5:4.0, 1.35:4.0 to 1.475:4.0, or 1.4:4.0 to 1.45:4.0, for example.

Further, the present KAlF₄ flux agents have an aluminum to fluorine molar ratio of 1.0:4.0.

Without wishing to be held to a particular theory, in pure KAlFₓ systems (having no other elements), increasing the potassium ratio to the aluminum and fluorine while maintaining a fixed aluminum to fluorine ratio results in an expanded melting point range. More particularly, such an alteration results in an expanded melting point range where the lower end of the range is expanded to provide a potassium/aluminum/fluorine flux agent having a reduced melt point as compared to known potassium/aluminum/fluorine flux agents.

The phase composition of the KAlF₄ flux agent includes a KAlF₄ phase and a K₂AlF₅(H₂O) phase. The KAlF₄ phase may comprise as little as 5 wt. %, 10 wt. %, or 15 wt. %, or as great as 50 wt. %, 55 wt. %, or 60 wt. %, or may be within any range defined between any two of the foregoing values, based on the total composition of the KAlF₄ and K₂AlF₅(H₂O) phases in the flux agent and as determined by X-ray powder diffraction with subsequent Rietveld analysis, such as between 5 wt. % and 60 wt. %, between 10 wt. % and 55 wt. % or between 15 wt. % and 50 wt. %, for example.

The K₂AlF₅(H₂O) phase may comprise as little as 40 wt. %, 45 wt. %, or 50 wt. %, or as great as 85 wt. %, 90 wt. %, or 95 wt. %, or may be within any range defined between any two of the foregoing values, based on the total composition of the KAlF₄ and K₂AlF₅(H₂O) phases in the flux agent and as determined by X-ray powder diffraction with subsequent Rietveld analysis, such as between 40 wt. % and 95 wt. %, between 45 wt. % and 90 wt. % or between 50 wt. % and 85 wt. %, for example.

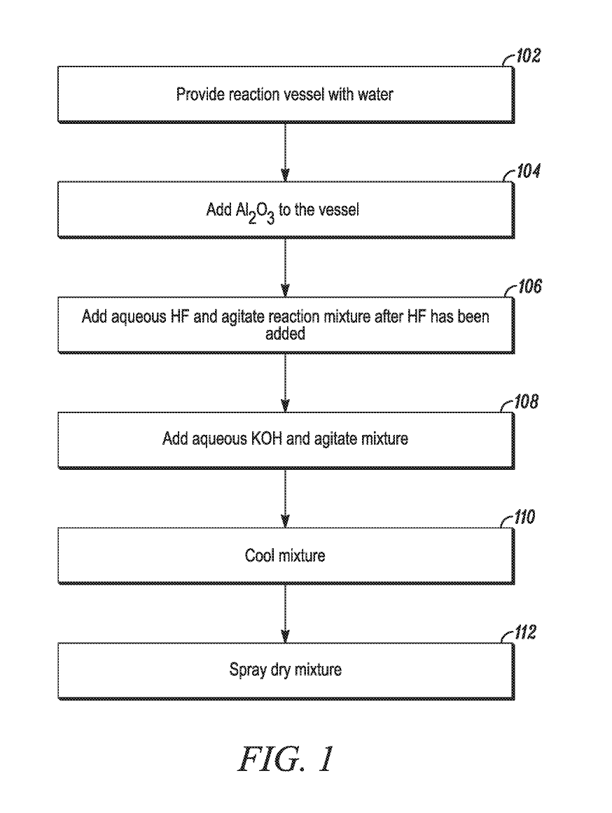

Referring now to FIG. 1, a method 100 to create low melting KAlF₄ is provided. At block 102, a reaction vessel, such as a beaker, is provided with water. Although not so limited, in one specific embodiment, 300 grams of water is provided in the reaction vessel.

At block 104, powdered aluminum oxide is added to the reaction vessel and is suspended in the water provided in block 102 via agitation. In an exemplary embodiment, 33.75 grams of aluminum oxide is added to the reaction vessel.

At block 106, aqueous hydrofluoric acid is added to the suspension within 20 minutes to form a reaction mixture. Aqueous hydrofluoric acid may have a concentration (based on weight percentage) as little as 50 wt. %, 52 wt. %, or 55 wt. %, or as great as 70 wt. %, 72 wt. %, or 75 wt. % or within any range defined between any two of the foregoing values, such as between 50 wt. % and 75 wt. %, between 52 wt. % and 72 wt. %, between 55 wt. % and 70 wt. %, for example. In an exemplary embodiment, the concentration (based on weight percentage) of the aqueous hydrofluoric acid is 59.5 wt. %. As the exothermic reaction proceeds and the HAlF₄ intermediate is produced, the temperature of the reaction mixture increases to as little as about 50° C., about 60° C., about 70° C., or as great as about 80° C., about 90° C., about 100° C., or within any range defined between any two of the foregoing values such as between about 70° C. and about 80° C. In an exemplary embodiment, the temperature within the mixture is about 80° C.

When the HF addition is completed, the reaction mixture is agitated at an elevated temperature as also included in block 106. An exemplary temperature of the reaction mixture may be as little as 70° C., 72° C., 74° C., or as great as 76° C., 78° C., 80° C., or within any range defined between any two of the foregoing values such as between 70° C. and 80° C., between 72° C. and 78° C., or between 74° C. and 76° C., for example. The reaction mixture may be stirred for additional time as up to 60 minutes. In an exemplary embodiment, the reaction mixture is stirred for an additional 15 minutes. In an exemplary embodiment, the temperature is between about 70° C. and 80° C. for an additional 15 minutes.

Method 100 then proceeds to block 108 where aqueous potassium hydroxide is added. Aqueous potassium hydroxide can be added via a dropping funnel or an additional dosing unit. In an exemplary embodiment, the flow rate of aqueous potassium hydroxide is 2.1 g/min. Without wishing to be held to a particular theory, it is believed that due to the increased level of potassium, the phase composition of the resulting flux powder changes and greater amounts of K₂AlF₅(H₂O) are obtained. It is believed that this leads to an increased melting point range (provided by a decrease in the lower end of the melting point range) of the composition due to the composition being close to an ideal eutectic system. Furthermore, it is believed that elevated reaction temperature and additional stirring times lead to a process that is more stable and reproducible overall.

Aqueous potassium hydroxide may have a concentration (based on weight percentage) as little as 45 wt. %, 46 wt. %, or 47 wt. %, or as great as 50 wt. %, 52 wt. %, or 55 wt. % or within any range defined between any two of the foregoing values, such as between 45 wt. % and 55 wt. %, 46 wt. % and 52 wt. %, or 47 wt. % and 50 wt. %, for example. In an exemplary embodiment, the concentration (based on weight percentage) of the aqueous potassium hydroxide is 49.2 wt. %. The amount of aqueous potassium hydroxide added may be as little as 50 grams, 54 grams, or 58 grams, or as great as 62 grams, 66 grams, or 70 grams, or within any range defined between any two of the foregoing values, such as 50 grams to 70 grams, 54 grams to 66 grams, or 56 grams to 62 grams, for example. In an exemplary embodiment, 64.2 grams of aqueous potassium hydroxide is added to the reaction vessel. In an exemplary embodiment, 64.2 grams of potassium hydroxide are added within 30 minutes of the completion of step 106.

At this point, KAlF₄ precursor precipitates within the reaction mixture. Due to the exothermic reaction, the temperature within the reaction mixture increases to as little as 60° C., 70° C., or 80° C., or as great as 90° C., 95° C., or 100° C., or within any range defined between any two of the foregoing values such as between 60° C. and 100° C. between 70° C. and 95° C., between 80° C. and 90° C., for example. The reaction mixture may be stirred for 10 minutes to 60 minutes at an elevated temperature. In an exemplary embodiment, the temperature to which the reaction mixture is increased is about 75° C. and the reaction mixture is stirred for an additional 60 minutes at a temperature between 70° C. and 80° C.

Method 100 then proceeds to block 110 where the reaction mixture of block 108 is cooled. The reaction mixture is cooled to a temperature as little as 30° C., 35° C., or 40° C., or as great as 45° C., 47° C., or 50° C., or within any range defined between any two of the foregoing values such as between 35° C. and 45° C., between 30° C. and 50° C., between 35° C. and 47° C., or between 40° C. and 45° C., for example. In an exemplary embodiment, the temperature to which the reaction mixture is cooled is about 40° C.

At block 112, the KAlF₄ precursor is isolated via spray drying to form the low melting KAlF₄ flux agent. During spray drying, the inlet temperature may be as little as 250° C., 275° C., or 300° C., or as great as 375° C., 400° C., or 420° C., or within any range defined between any two of the foregoing values such as between 250° C. and 420° C., 275° C. to 400° C., or 300° C. to 375° C., for example. The outlet temperature may be as little as 100° C., 120° C., or 130° C., or as great as 140° C., 150° C., 165° C., or within any range defined between any two of the foregoing values such as between 100° C. and 165° C., 120° C. and 150° C., or 130° C. and 140° C., for example. In an exemplary embodiment, the inlet temperature is 250° C., and the outlet temperature is between 105° C. and 110° C. Both nozzles and rotary discs can be used to atomize the reaction mixture for spray drying. The reaction mixture (KAlF₄ precursor) is fed to the spray dryer at a temperature between 20° C. and 60° C.

### II. Properties of Flux Agent

As mentioned earlier, the KAlF₄ flux agent of the present disclosure has a relatively lower melting point than existing KAlF₄ flux agents. The flux is placed in a ceramic crucible, and the flux is melted using a Bunsen burner. The melting point of the flux is determined by using a temperature sensor and dipping the sensor into the melt of the flux to determine the melting point.

The melting point of the present KAlF₄ flux agent may be as little as 530° C., 535° C., or 537° C., or as great as 540° C., 545° C., or 550° C., or may be within any range defined between any two of the foregoing values, such as between 530° C. to 550° C., 535° C. and 545° C., or 537° C. to 540° C., for example.

In an exemplary embodiment, the melting point of the present KAlF₄ flux agent may be as little as 535° C., 536° C., 537° C., 538° C., or 539° C., or as great as 540° C., 541° C., 542° C., 543° C., 544° C., or 545° C., or may be within any range defined between any two of the foregoing values, such as between 535° C. and 545° C., 536° C. and 544° C., 537° C. and 543° C., 538° C. and 542° C., 539° C. and 541° C., for example.

In a further exemplary embodiment, the KAlF₄ flux agent has a melting point of 540° C.

Advantageously, the present KAlF₄ flux agent has a lower melting point which allows for the use of solders and alloys with lower melting points for brazing applications. The lower melting point may also allow for faster brazing of standard alloys. Moreover, due to earlier starting of the brazing process, cycle times may be reduced, and the output range of brazed parts may be increased.

As used herein, the phrase “within any range defined between any two of the foregoing values” literally means that any range may be selected from any two of the values listed prior to such phrase regardless of whether the values are in the lower part of the listing or in the higher part of the listing. For example, a pair of values may be selected from two lower values, two higher values, or a lower value and a higher value.

### III. Examples

### Preparation of Example 1

To prepare Example 1, 33.75 grams of aluminum oxide (Al₂O₃(H₂O)₃) were added to a beaker and suspended in 300 grams of water. Then, 58.2 grams of aqueous hydrofluoric acid (59.5 wt. % solution in water) were added within 20 minutes to the stirred reaction mixture. As the reaction produced HAlF₄, the temperature of the reaction mixture increased to about 80° C. Once the addition of HF was completed, the reaction mixture was stirred for an additional 15 minutes at a temperature between 70° C. and 80° C.

64.2 grams of potassium hydroxide (KOH, 49.2 wt. % solution in water) were added within 30 minutes (flow rate of 2.1 g/min). At this point, KAlF₄ precipitated from the reaction mixture.

The temperature of the reaction mixture increased to about 75° C., and the reaction mixture was stirred for an additional 60 minutes at about 70° C.-80° C. Then, the reaction mixture was cooled to about 40° C.

The product was then isolated via spray drying where the inlet temperature was about 250° C. and the outlet temperature was between about 105° C. and about 110° C.

Example 1 had a potassium to aluminum to fluorine ratio (K:Al:F) of 1.3:1.0:4.0 and had a phase composition of KAlF₄ of 15 wt. % and of K₂AlF₅(H₂O) of 82%. The melting point of Example 1 was 540° C.

### Preparation of Comparative Example 1 (Comp. Ex. 1)

To prepare Comparative Example 1, 33.75 grams of aluminum oxide (Al₂O₃(H₂O)₃) were added to a beaker and suspended in 300 grams of water. Then, 58.2 grams of aqueous hydrofluoric acid (59.5 wt. % solution in water) were added within 20 minutes to the stirred reaction mixture. As the reaction produced HAlF₄, the temperature of the reaction mixture increased to about 80° C. Once the addition of HF was completed, the reaction mixture was stirred for an additional 15 minutes at a temperature between 70° C. and 80° C.

59.3 grams of potassium hydroxide (KOH, 45 wt. % solution in water) were added within 30 minutes. At this point, KAlF₄ precipitated from the reaction mixture.

The temperature of the reaction mixture increased to about 75° C., and the reaction mixture was stirred for an additional 60 minutes at about 70° C.-80° C. Then, the reaction mixture was cooled to about 40° C.

The product was then isolated via spray drying where the inlet temperature was about 250° C. and the outlet temperature was between about 105° C. and about 110° C.

Comparative Example 1 had a potassium to aluminum to fluorine ratio (K:Al:F) of 1.1:1.0:4.0 and a melting point of 559° C.

### Comparison Between Comp. Ex. 1 and Ex. 1

As mentioned earlier, the melting point of the flux agent of Ex. 1 is about 540° C., which is lower than conventional flux agents. The KAlF₄ flux agent having a lower melting point allows for the use of solders and alloys with lower melting points for brazing applications. The lower melting point may also allow for faster brazing of standard alloys. Moreover, due to earlier starting of the brazing process, cycle times may be reduced, and the output range of brazed parts may be increased.

Various modifications and additions can be made to the exemplary embodiments discussed without departing from the scope of the present invention. For example, while the embodiments described above refer to particular features, the scope of this invention also includes embodiments having different combinations of features and embodiments that do not include all of the above described features.

1. A KAlF₄ flux agent comprising:
a K:Al ratio between 1.3:1 and 1.5:1;
a K:F ratio between 1.3:4 and 1.5:4; and
a melting point between 530° C. and about 550° C.

2. The flux agent of claim 1, wherein the flux agent has a phase composition of KAlF₄ between about 5 wt. % and about 60 wt. % and of K₂AlF₅(H₂O) between 40 wt. % and 95 wt. %, based on the total composition of the KAlF₄ and K₂AlF₅(H₂O) phases in the flux agent.

3. The flux agent of claim 2, wherein the flux agent has a phase composition of KAlF₄ between about 15 wt. % and about 50 wt. % and of K₂AlF₅(H₂O) between 50 wt. % and 85 wt. %, based on the total composition of the KAlF₄ and K₂AlF₅(H₂O) phases in the flux agent.

4. The flux agent of claim 1, wherein the flux agent has a melting point between 535° C. and 545° C.

5. The flux agent of claim 1, wherein the Al:F ratio is 1:4.

6. A KAlF₄ flux agent, comprising:
a K:Al ratio between 1.3:1 and 1.5:1;
a K:F ratio between 1.3:4 and 1.5:4;
a Al:F ratio of 1:4; and
a phase composition of KAlF₄ between about 5 wt. % and about 60 wt. % and of K₂AlF₅(H₂O) between 40 wt. % and 95 wt. %, based on the total composition of the KAlF₄ and K₂AlF₅(H₂O) phases in the flux agent.

7. The flux agent of claim 6, wherein the flux agent has a phase composition of KAlF₄ between about 15 wt. % and about 50 wt. % and of K₂AlF₅(H₂O) between 50 wt. % and 85; wt. %, based on the total composition of the KAlF₄ and K₂AlF₅(H₂O) phases in the flux agent.

8. The flux agent of claim 7, wherein the flux agent has a melting point between 535° C. and 545° C.

9. The flux agent of claim 8, wherein the melting point is about 540° C.

10. A method of producing a flux agent, comprising:
providing a reaction vessel containing water;
adding aluminum oxide to the reaction vessel under agitation;
adding an aqueous hydrofluoric acid to form a reaction mixture, the aqueous hydrofluoric acid having a concentration between 50 wt. % and 75 wt. %;
adding an aqueous potassium hydroxide to the reaction mixture, wherein the aqueous potassium hydroxide has a concentration between 45 wt. % and 55 wt. %; and
cooling the reaction mixture to between 35° C. and 45° C.; and
spray drying the reaction mixture to produce the flux agent, wherein the flux agent has a K:Al ratio between 1.3:1 and 1.5:1.

11. The method of claim 10, wherein the flux agent has a melting point between 530° C. and 570° C.

12. The method of claim 10, wherein the melting point is between 535° C. and 545° C.

13. The method of claim 10, wherein the K:F ratio is between 1.3:4 and 1.5:4.

14. The method of claim 10, wherein the flux agent has a phase composition of KAlF₄ between about 5 wt. % and about 60 wt. % and of K₂AlF₅(H₂O) between 40 wt. % and 95 wt. %, based on the total composition of the KAlF₄ and K₂AlF₅(H₂O) phases in the flux agent.

15. The flux agent of claim 14, wherein the flux agent has a phase composition of KAlF₄ between about 15 wt. % and about 50 wt. % and of K₂AlF₅(H₂O) between 50 wt. % and 85 wt. %, based on the total composition of the KAlF₄ and K₂AlF₅(H₂O) phases in the flux agent.
